(19) United States
(12) Patent Application Publication
(10) Pub. No.: US 2026/0214378 A1
(43) Pub. Date: Jul. 23, 2026

(54) SOUND ACQUISITION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Shuhei SHIMANOE, Nisshin-shi (JP); Takashi TAKAZAWA, Nisshin-shi (JP); Yoshinori TSUCHIYA, Nisshin-shi (JP); Masaaki KAWAUCHI, Nisshin-shi (JP)

(21) Appl. No.: 19/427,076

(22) Filed: Dec. 19, 2025

(30) Foreign Application Priority Data
Jan. 20, 2025 (JP) 2025-007846

(51) Int. Cl. H04R 1/28; H04R 1/04; H04R 1/40

(52) U.S. Cl. CPC H04R 1/2884; H04R 1/04; H04R 1/406; H04R 2201/021; H04R 2410/01; H04R 2499/13

(57) ABSTRACT

A sound acquisition device for use with an object having a first member defining a first space and a second member defining a second space together with the first member includes a substrate having a substrate sound hole communicating with the first space. A first microphone is disposed on the substrate and acquires sound generated in the first space via the substrate sound hole. A second microphone is disposed in the second space and acquires vibration sound generated by the second member. A coherence of the vibration sound acquired by the second microphone with respect to the sound acquired by the first microphone is 0.4 or greater.

### CROSS REFERENCE TO RELATED APPLICATION

This application is based on and claims the benefits of priority of Japanese Patent Application No. 2025-007846 filed on Jan. 20, 2025. The entire disclosure of which is incorporated herein by reference.

### TECHNICAL FIELD

The present disclosure relates to a sound acquisition device.

### BACKGROUND

Conventionally, a voice processing device equipped with a first microphone, a second microphone, and noise reduction means is known.

### SUMMARY

According to at least one embodiment, a sound acquisition device for use with an object having a first member defining a first space and a second member defining a second space together with the first member includes a substrate having a substrate sound hole communicating with the first space. A first microphone may be disposed on the substrate and acquires sound generated in the first space via the substrate sound hole. A second microphone may be disposed in the second space and acquires vibration sound generated by the second member. A coherence of the vibration sound acquired by the second microphone with respect to the sound acquired by the first microphone may be 0.4 or greater.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a perspective view illustrating an object in which a sound acquisition device according to a first embodiment is used.

FIG. 2 is a cross-sectional view of the sound acquisition device.

FIG. 3 is a diagram showing a relationship between coherence and voice recognition rate.

FIG. 4 is a diagram showing a relationship between a distance from a reference position to a microphone in a left-right direction of a vehicle and the coherence.

FIG. 5 is a cross-sectional view of a sound acquisition device according to a second embodiment.

FIG. 6 is a diagram illustrating a substrate and a first microphone of the sound acquisition device.

FIG. 7 is a diagram illustrating a processor of the sound acquisition device.

FIG. 8 is a cross-sectional view of a sound acquisition device according to a third embodiment.

FIG. 9 is a cross-sectional view of a sound acquisition device according to a fourth embodiment.

FIG. 10 is a cross-sectional view of a sound acquisition device according to a fifth embodiment.

FIG. 11 is a diagram illustrating a substrate, a first microphone, and a second microphone of the sound acquisition device.

FIG. 12 is a cross-sectional view of a sound acquisition device according to a sixth embodiment.

FIG. 13 is a cross-sectional view of a sound acquisition device according to a seventh embodiment.

FIG. 14 is a cross-sectional view of a housing, a substrate, a first microphone, and a second microphone of the sound acquisition device.

### DETAILED DESCRIPTION

To begin with, examples of relevant techniques will be described.

A conventional voice processing device includes a first microphone, a second microphone, and noise reduction means. The first microphone is provided in a ceiling of a vehicle or an accessory thereof, and inputs a mixed sound in which voices of vehicle occupants and noise inside the vehicle are mixed, and outputs a first signal. The second microphone is provided at a position in a gap between the ceiling and a vehicle windshield, farther from the vehicle occupants than the first microphone, and, by utilizing the ceiling of the vehicle, blocks the voices of the vehicle occupants while inputting noise inside the vehicle, and outputs a second signal. The noise reduction means includes an adaptive filter using an adaptive algorithm, and outputs an enhanced voice signal based on the first signal and the second signal.

According to studies by the inventors, in a voice processing device according to a comparative example, a coherence between sound input to the second microphone provided in the gap between the ceiling and the windshield and sound input to the first microphone provided in the ceiling is relatively low. When the coherence between the sound input to the second microphone and the sound input to the first microphone is low, a solution calculated by the adaptive filter using the adaptive algorithm becomes less likely to converge. Therefore, in the voice processing device according to the comparative example, noise reduction effects of the adaptive filter using the adaptive algorithm is reduced.

In contrast to the comparative example, according to a sound acquisition device of the present disclosure, the noise reduction effects achieved by the adaptive algorithm can be improved.

According to one aspect of the present disclosure, a sound acquisition device for use with an object having a first member defining a first space and a second member defining a second space together with the first member includes a substrate having a substrate sound hole communicating with the first space. A first microphone is disposed on the substrate and acquires sound generated in the first space via the substrate sound hole. A second microphone is disposed in the second space and acquires vibration sound generated by the second member. A coherence of the vibration sound acquired by the second microphone with respect to the sound acquired by the first microphone is 0.4 or greater.

According to this configuration, since the coherence between the sound acquired by the second microphone and the sound acquired by the first microphone is relatively high, a solution calculated using the adaptive algorithm is more likely to converge. Therefore, noise reduction effect achieved by the adaptive algorithm is improved.

### First Embodiment

A sound acquisition device of the present embodiment improves noise reduction effects achieved by an adaptive algorithm. The sound acquisition device also functions as a speech acquisition device that acquires speech uttered by a person. For example, this sound acquisition device is used in an object. First, the object will be described.

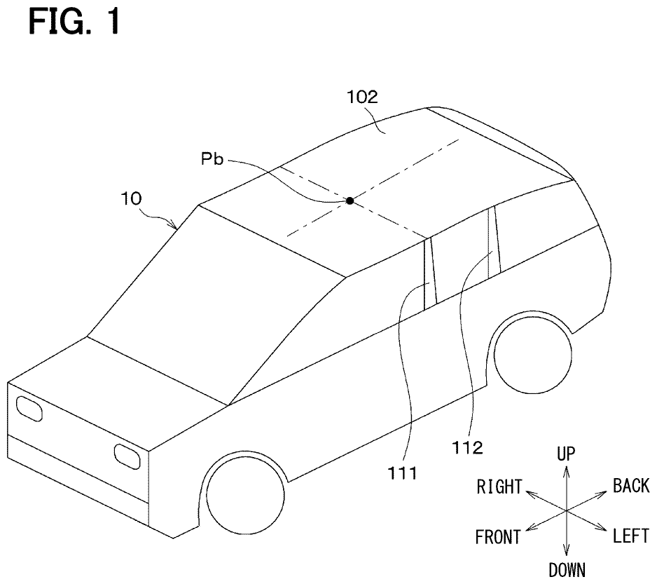

As shown in FIG. 1, the object 10 is, for example, a mobile body. The mobile body is, for example, a conveyance. The mobile body is a conveyance for carrying people, and has an interior space for accommodating occupants. The mobile body is, for example, a vehicle. The object 10 further includes a first member 101, a second member 102, a first connection member 111, and a second connection member 112.

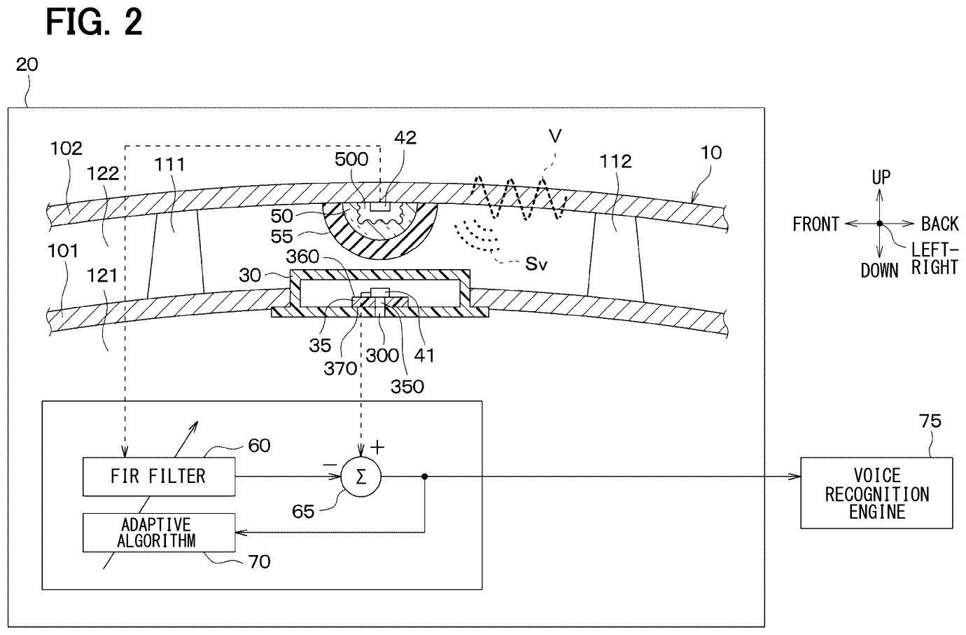

As shown in FIG. 2, the first member 101 is, for example, an interior member installed inside the vehicle. Furthermore, the first member 101 is formed in a plate extending in a direction perpendicular to a vertical direction. The first member 101 also defines a first space 121. Here, the first space 121 refers to a closed space inside a vehicle compartment.

As shown in FIGS. 1 and 2, the second member 102 is, for example, a ceiling member that forms a ceiling of the vehicle. Furthermore, the second member 102 is formed in a plate extending in a direction perpendicular to the vertical direction. The second member 102, together with the first member 101, defines a second space 122. The second space 122 is a closed space.

The first connection member 111 is, for example, a B-pillar of the vehicle. Furthermore, the first connection member 111 is connected to the second member 102. Additionally, the first connection member 111 extends in a direction intersecting both a front-rear direction and a left-right direction of the vehicle, that is, in this case, the vertical direction.

The second connection member 112 is, for example, a C-pillar of the vehicle. Furthermore, the second connection member 112 is connected to a rear side of the second member 102 relative to the first connection member 111 in the vehicle. Additionally, the second connection member 112 extends in a direction intersecting both the front-rear direction and the left-right direction, in this case, in the vertical direction.

As described above, the object 10 is constructed in this manner. Next, the sound acquisition device used in the object 10 will be described.

As shown in FIG. 2, the sound acquisition device 20 includes a housing 30, a substrate 35, a first microphone 41, a second microphone 42, a sound-absorbing member 50, a sound-insulating member 55, a variable FIR (Finite Impulse Response) filter 60, an adder 65, and an execution unit 70.

The housing 30 is formed in a box shape from resin or the like. Furthermore, a part of the housing 30 is inserted into a hole formed in the first member 101. The hole formed in the first member 101 is located, in the front-rear direction of the vehicle, between the first connection member 111 and the second connection member 112.

Therefore, the housing 30 is positioned, in the front-rear direction of the vehicle, between the first connection member 111 and the second connection member 112. In addition, the housing 30 is fixed to the first member 101 by screws or the like (not shown). Furthermore, the housing 30 has a housing sound hole 300. The housing sound hole 300 communicates with the first space 121.

The substrate 35 is a printed circuit board. In addition, the substrate 35 is housed within the housing 30. Furthermore, since the housing 30 is positioned between the first connection member 111 and the second connection member 112 in the front-rear direction, the substrate 35 is also positioned between the first connection member 111 and the second connection member 112. In addition, the substrate 35 has a substrate sound hole 350, a substrate front surface 360, and a substrate rear surface 370.

The substrate sound hole 350 communicates with the first space 121 via the housing sound hole 300. Here, the substrate front surface 360 refers to an upper-side surface of the substrate 35. The substrate rear surface 370 is the surface of the substrate 35 opposite to the substrate front surface 360, and here, it refers to a lower-side surface of the substrate 35.

The first microphone 41 is, for example, an omnidirectional microphone. Furthermore, the first microphone 41 is housed within the housing 30. Additionally, the first microphone 41 is disposed on the substrate 35. Furthermore, since the substrate 35 is positioned between the first connection member 111 and the second connection member 112 in the front-rear direction of the vehicle, the first microphone 41 is also positioned between the first connection member 111 and the second connection member 112. Additionally, the first microphone 41 is disposed near a location of the substrate sound hole 350 on the substrate surface 360. As a result, the first microphone 41 acquires sounds generated in the first space 121, such as voices and noises inside the vehicle compartment, through the housing sound hole 300 and the substrate sound hole 350. Furthermore, the first microphone 41 outputs a signal corresponding to the acquired sound to the adder 65, which will be described later.

Here, the noise inside the vehicle compartment includes both diffuse noise and directional noise. The diffuse noise refers to noise with low directivity, such as driving noise and wind noise generated, for example, by the vibration of the entire vehicle. The directional noise refers to noise with higher directivity than diffuse noise, such as voices of people other than voices of people inside the vehicle compartment or wind noise from an air conditioner.

In addition, here, a vibration sound Sv of the vehicle generated from the vibration V of the second member 102 serves as a main source of the diffuse noise. Furthermore, the vibration sound Sv enters the first space 121, for example, via the second space 122 and the first member 101. Therefore, a main component of the diffuse noise inside the vehicle compartment is the vibration sound Sv.

Therefore, the second microphone 42 is mounted on the second space 122 side of the second member 102. Accordingly, the second microphone 42 is disposed within the second space 122. As a result, the second microphone 42 acquires the vibration sound Sv generated in the second member 102. In addition, the second microphone 42 outputs a signal corresponding to the acquired vibration sound Sv to the variable FIR filter 60, which will be described later. As a result, the vibration sound Sv acquired by the second microphone 42 is input to the variable FIR filter 60. Furthermore, when the second microphone 42 is projected in the vertical direction, its projected position overlaps with that of the first microphone 41. In other words, when the position of the second microphone 42 is orthogonally projected onto a plane perpendicular to the vertical direction, the projected position of the second microphone 42 overlaps with the position of the first microphone 41. That is, when the second microphone 42 is projected onto a plane perpendicular to the vertical direction, the projected area of the second microphone 42 at least partially overlaps with the area of the first microphone 41.

Here, a frequency is “ω”. A Fourier transform of time-series data x(t) of the sound acquired by the first microphone 41 is denoted as X(ω). A Fourier transform of time-series data y(t) of the sound acquired by the second microphone 42 is denoted as Y(ω).

At this time, a coherence Cohxy(ω) at frequency ω between the sound acquired by the first microphone 41 and the sound acquired by the second microphone 42 is expressed by a following equation (1). In the following equation (1), “E” is a function for calculating the expected value, for example, a function that performs time averaging or the like. The expression ei^{×(θY-θX)} represents a phase difference between the sound acquired by the first microphone 41 and the sound acquired by the second microphone 42. The symbol “e” is the base of the natural logarithm (Napier's constant). The symbol “i” is the imaginary unit.

$$\begin{matrix}〈 Math 1 〉 & \\ Cohxy ( ω ) = \frac{\vert E \{ \vert X ( ω ) \vert \times \vert Y ( ω ) \vert \times {e}^{i \times ( θ Y - θ X )} \} {\vert}^{2}}{E \{ \vert X ( ω ) {\vert}^{2} \} \times E \{ \vert Y ( ω ) {\vert}^{2} \}} & ( 1 )\end{matrix}$$

Furthermore, when the phase difference between the sound acquired by the first microphone 41 and the sound acquired by the second microphone 42 is always constant, e^{i×(θY-θX)} also remains constant. Therefore, in this case, since e^{i×(θY-θX)} can be factored out of E, the numerator and denominator of the equation (1) become equal. Accordingly, in this case, the coherence Cohxy(ω) becomes 1.0, which is the maximum value.

Also, when the phase difference between the sound acquired by the first microphone 41 and the sound acquired by the second microphone 42 is not constant and fluctuates, e^{i×(θY-θX)} cannot be factored out of E. Furthermore, since the phase difference changes over time, when E is averaged over time, the time-averaged E becomes smaller. Therefore, in this case, the coherence Cohxy(ω) approaches its minimum value of 0.

In addition, in the sound acquisition device 20, the coherence Cohxy(ω) of the sound acquired by the second microphone 42 with respect to the sound acquired by the first microphone 41 is set to be between 0.4 and 1.0, inclusive. A positional relationship between the first microphone 41 and the second microphone 42, as well as the surrounding environment and other factors, are adjusted so that the coherence Cohxy(ω) falls within a range of 0.4 to 1.0.

Furthermore, the second microphone 42 is positioned between the first connection member 111 and the second connection member 112 in the front-rear direction of the vehicle. Accordingly, the first microphone 41 and the second microphone 42 are positioned between the first connection member 111 and the second connection member 112 in the front-rear direction of the vehicle. As a result, the position of the first microphone 41 and the position of the second microphone 42 become relatively close to each other. Therefore, the coherence Cohxy(ω) is more likely to be 0.4 or higher.

Here, as shown in FIG. 1, a position whose longitudinal location is at a center of a boundary between the second member 102 and the first connection member 111, and whose lateral location is at a center in the left-right direction, is defined as a reference position Pb.

A distance from the reference position Pb in the left-right direction to the first microphone 41 is set to 300 mm or less. Furthermore, a distance from the reference position Pb in the left-right direction to the second microphone 42 is set to 300 mm or less.

Returning to FIG. 2, the sound-absorbing member 50 is made of material having sound-absorbing properties, such as sponge or foamed urethane. The sound-absorbing member 50 is fixed to a portion of the second member 102 on the second space 122 side by means such as adhesion or bonding. Furthermore, the sound-absorbing member 50, together with the second member 102, covers the second microphone 42.

In addition, an internal space 500 is formed between the sound-absorbing member 50 and the second microphone 42. Furthermore, the internal space 500 is formed in an uneven (concave-convex) shape. As a result, generation of standing waves within the internal space 500 is reduced. Therefore, it is possible to prevent the frequency characteristics of the audio signal acquired by the second microphone 42 from being altered by standing waves in the internal space 500.

The sound-insulating member 55 is formed, for example, from material having sound-insulating properties such as rubber, resin, or metal. In addition, the sound-insulating member 55 is fixed to a portion of the second member 102 on the second space 122 side by means such as adhesion or bonding. Furthermore, the sound-insulating member 55, together with the second member 102, covers the second microphone 42 and the sound-absorbing member 50. As a result, the sound-insulating member 55 blocks sounds such as voices generated in the first space 121 that propagate toward the second microphone 42. Therefore, the sound-insulating member 55 suppresses the transmission of sounds generated in the first space 121 to the second microphone 42. Therefore, compared to a case where the sound-insulating member 55 is not present, the second microphone 42 becomes less likely to pick up sounds generated in the first space 121 and more likely to capture the vibration sound Sv.

The variable FIR filter 60 acquires a signal corresponding to the sound picked up by the second microphone 42 from the second microphone 42. In addition, the variable FIR filter 60 adjusts amplitude and phase of the sound acquired from the second microphone 42. Furthermore, the variable FIR filter 60 outputs a signal corresponding to the sound whose amplitude and phase have been adjusted to the adder 65, which will be described later.

The adder 65 acquires, from the variable FIR filter 60, a signal corresponding to the sound whose amplitude and phase have been adjusted by the variable FIR filter 60. In addition, the adder 65 inverts polarity of the sound whose amplitude and phase have been adjusted by the variable FIR filter 60. Furthermore, the adder 65 acquires, from the first microphone 41, a signal corresponding to the sound acquired by the first microphone 41. In addition, the adder 65 adds the above polarity-inverted signal to the signal acquired from the first microphone 41. Furthermore, the adder 65 outputs the added signal to an adaptive algorithm execution unit 70 and a voice recognition engine 75, which will be described later. The voice recognition engine 75 recognizes, based on the audio signal from the adder 65, for example, voice information indicated by the voice of a person inside the vehicle compartment. In addition, the voice recognition engine 75 outputs a signal for executing control corresponding to the recognized speech information to various in-vehicle devices such as a navigation device or an air conditioner (not shown) of the vehicle. As a result, various in-vehicle devices such as the navigation device and the air conditioner execute control corresponding to the voice information. Here, the sound acquisition device 20 does not include the voice recognition engine 75; instead, the voice recognition engine 75 is arranged outside the sound acquisition device 20. Contrary to this, the sound acquisition device 20 may alternatively be provided with the voice recognition engine 75.

The execution unit 70 includes a microcomputer or the like, and acquires the above-added signal from the adder 65. Furthermore, the execution unit 70 performs processing on the signal acquired from the adder 65 using an adaptive algorithm such as the LMS (Least Mean Square) algorithm or the RLS (Recursive Least Squares) algorithm. As a result, the execution unit 70 automatically updates filter coefficients of the variable FIR filter 60. When this update is performed, the variable FIR filter 60 extracts the vibration sound Sv, which should be removed from the sound acquired by the first microphone 41, from the sound acquired by the second microphone 42. Accordingly, noise contained in the sound acquired by the second microphone 42 is reduced by the adaptive algorithm.

In addition, the signal in which the vibration sound Sv to be removed from the sound acquired by the first microphone 41 has been extracted is output to the adder 65. In the adder 65, by adding the above-mentioned inverted signal and the signal acquired from the first microphone 41, the sound adjusted by the variable FIR filter 60 is removed from the sound acquired by the first microphone 41. Therefore, in the adder 65, the vibration sound Sv is removed from the sound acquired by the first microphone 41. Furthermore, the signal of the sound from which the vibration sound Sv has been removed from the sound acquired by the first microphone 41 is output to the voice recognition engine 75. Accordingly, a decline in the voice recognition accuracy in the voice recognition engine 75 is reduced.

As described above, the sound acquisition device 20 of the first embodiment is configured as described. Next, the improvement in noise reduction effects by the adaptive algorithm in the sound acquisition device 20 will be described.

Here, in the sound processing device according to the comparative example, the coherence of the sound input to the second microphone provided in the gap between the ceiling member and the windshield, with respect to the sound input to the first microphone provided in the ceiling member, is relatively low. When the coherence between the sound input to the second microphone and the sound input to the first microphone is low, a solution calculated by the adaptive filter using the adaptive algorithm becomes less likely to converge. Therefore, in the voice processing device according to the comparative example, noise reduction effects of the adaptive filter using the adaptive algorithm is reduced.

Contrary to this, in the sound acquisition device 20 of the present embodiment, the coherence Cohxy(ω) of the sound acquired by the second microphone 42 with respect to the sound acquired by the first microphone 41 is set to 0.4 or higher.

As a result, since the coherence Cohxy(ω) of the sound acquired by the second microphone 42 with respect to the sound acquired by the first microphone 41 is relatively high, the solution calculated using the adaptive algorithm is more likely to converge. Therefore, the noise reduction effects by the adaptive algorithm is improved.

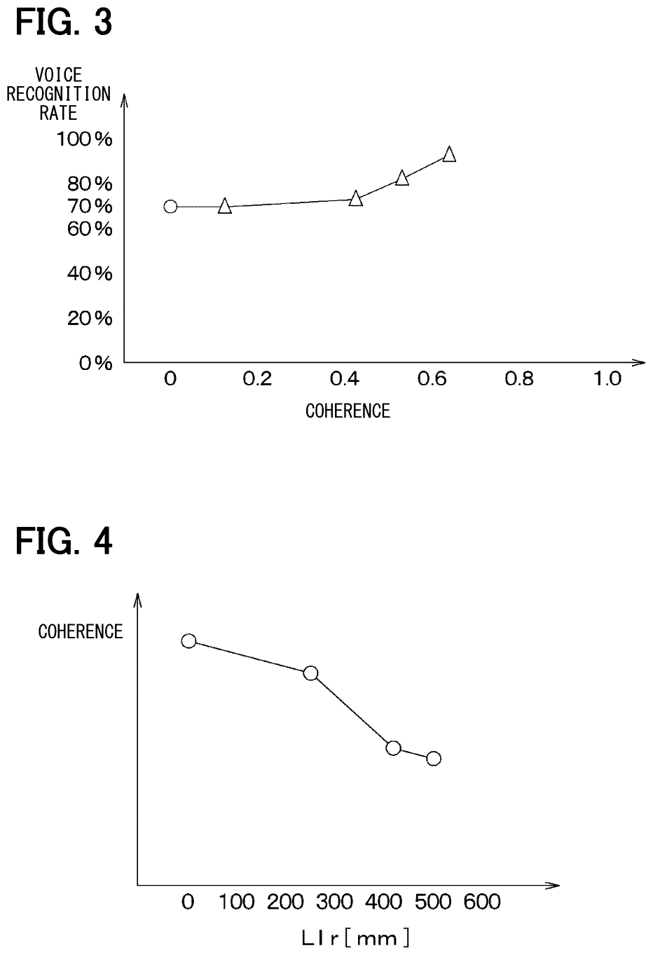

As a result, it becomes easier to extract only the vibration sound Sv, which should be removed from the sound acquired by the first microphone 41, from the sound acquired by the second microphone 42. Therefore, as shown in FIG. 3, while the voice recognition rate of the voice recognition engine 75 remains constant at 70% when the coherence Cohxy(ω) is less than 0.4, the voice recognition rate increases to 70% or higher when the coherence Cohxy(ω) is 0.4 or greater. The voice recognition rate refers to a value indicating accuracy of the voice recognition results.

In addition, the sound acquisition device 20 of the first embodiment also provides the effects described below.

The first microphone 41 and the second microphone 42 are positioned between the first connection member 111 and the second connection member 112 in the front-rear direction of the vehicle.

As a result, the position of the first microphone 41 and the position of the second microphone 42 become relatively close to each other. Therefore, the coherence Cohxy(ω) is more likely to be 0.4 or higher.

Here, as shown in FIG. 4, when the distance from the reference position Pb in the left-right direction of the vehicle to the first microphone 41 and the second microphone 42 is greater than 300 mm, the coherence Cohxy(ω) decreases rapidly. In FIG. 4, the distance from the reference position Pb in the left-right direction of the vehicle to the first microphone 41 and the second microphone 42 is indicated as Llr.

Contrary to this, in the sound acquisition device 20 of the present embodiment, the distance from the reference position Pb in the left-right direction of the vehicle to the first microphone 41 is set to 300 mm or less. The distance from the reference position Pb in the left-right direction of the vehicle to the second microphone 42 is set to 300 mm or less.

As a result, a rapid decrease in coherence Cohxy(ω) is reduced. Therefore, the coherence Cohxy(ω) is more likely to be 0.4 or higher.

Returning to FIG. 2, the first member 101 and the second member 102 are formed in a plate shape extending in a direction perpendicular to the vertical direction.

Here, when the first member 101 and the second member 102 are formed in a plate shape, dominant sounds such as vibration sound Sv, which are types of diffuse noise, are more likely to be generated. Therefore, when the first member 101 and the second member 102 are formed in a plate shape, the noise reduction effects of the adaptive algorithm in the sound acquisition device 20 of the present embodiment is more likely to be enhanced.

The substrate 35 has the substrate sound hole 350 that communicates with the first space 121. The first microphone 41 is disposed on the substrate 35 and acquires sound generated in the first space 121 through the substrate sound hole 350. The second microphone 42 is disposed within the second space 122. The first member 101 is an interior member installed in the vehicle. The second member 102 is a ceiling member that forms the ceiling of the vehicle.

Furthermore, when the first microphone 41 is projected in the vertical direction, the projected first microphone 41 overlaps with the second microphone 42.

As a result, compared to a case where the projected first microphone 41 does not overlap with the second microphone 42, after the second microphone 42 is disposed in a hole or the like of the vehicle 10, it becomes easier to arrange the first microphone 41 together with the substrate 35. Therefore, it becomes easier to assemble the substrate 35, the first microphone 41, and the second microphone 42 to the vehicle 10.

### Second Embodiment

In a second embodiment, a configuration of a first microphone 41 differs from that of the first embodiment. In addition, a sound acquisition device 20 further includes a microphone array processor 80. The other components are similar to those of the first embodiment.

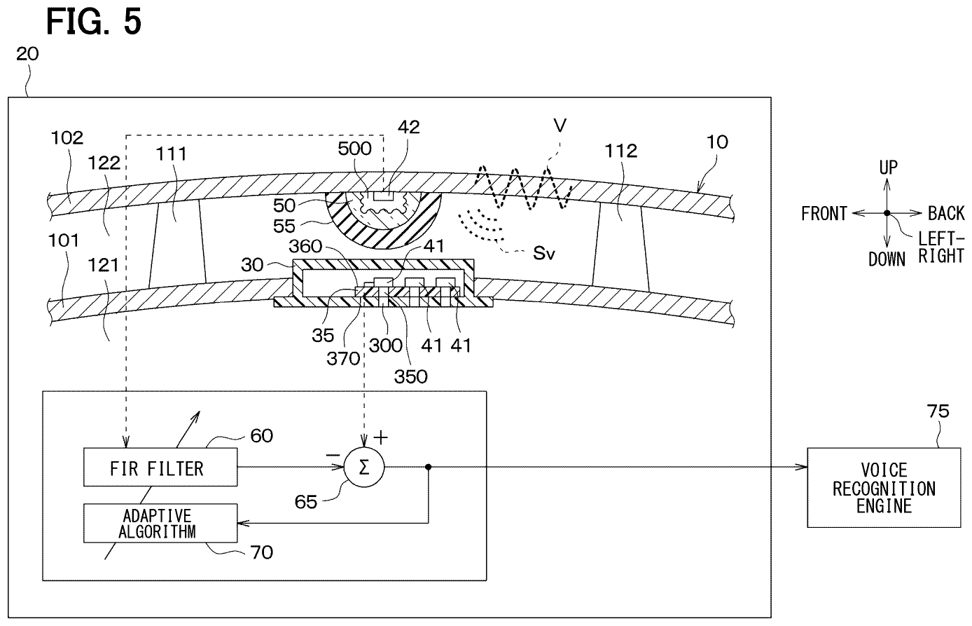

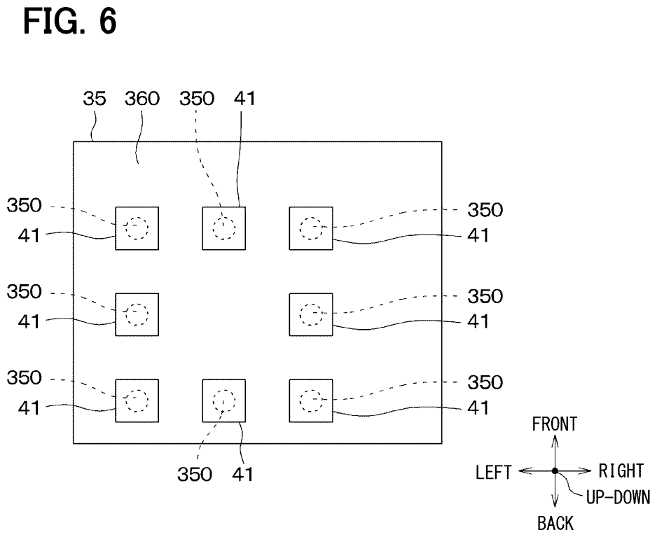

More specifically, as shown in FIGS. 5 and 6, the first microphones 41 are arranged in a row in one direction, for example, in the front-rear direction of the vehicle. Furthermore, the first microphones 41 are also arranged in a row in a direction intersecting the aforementioned direction, for example, in the left-right direction of the vehicle. Accordingly, the first microphones 41 are an array microphone. Therefore, the number of substrate sound holes 350 corresponds to the number of first microphones 41.

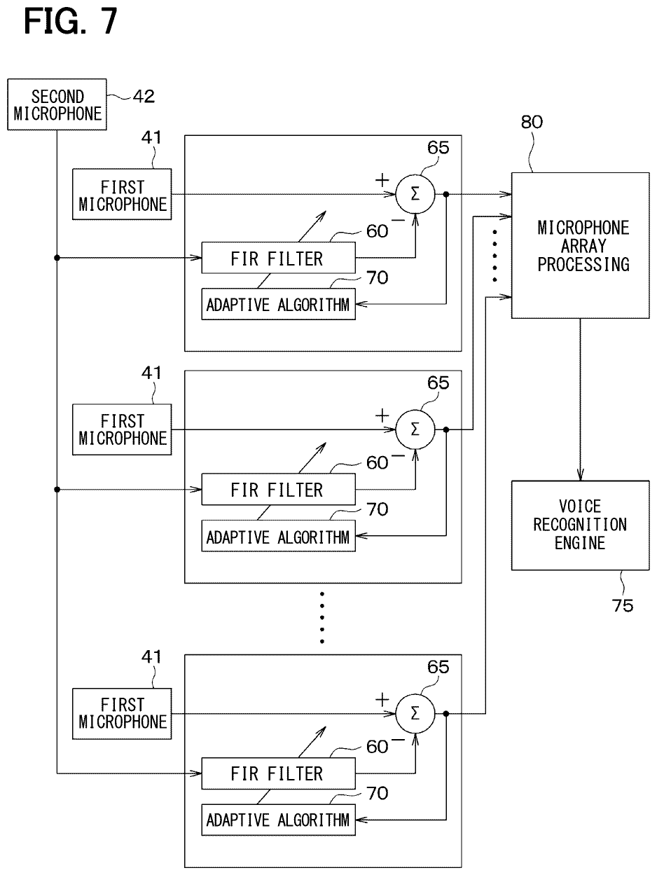

Further, as shown in FIG. 7, the signals corresponding to the sounds acquired by each of the first microphones 41 are processed by the adder 65, the variable FIR filter 60, and the execution unit 70, each corresponding to the respective first microphone 41.

Then, the processor 80 acquires the signals from each of the adders 65. Furthermore, the processor 80 performs microphone array signal processing, such as delay-and-sum or blind source separation, on the acquired signals. In addition, the processor 80 outputs the signal processed by the microphone array signal processing to the voice recognition engine 75. The voice recognition engine 75 converts the audio of the signal processed by the microphone array signal processing into character data.

As described above, the sound acquisition device 20 of the second embodiment is configured in this manner. In the second embodiment as well, it is the same as in the first embodiment. Furthermore, in the second embodiment, the effects described below are also achieved.

The first microphones 41 are arranged in multiple rows in one direction, and are also arranged in multiple rows in a direction intersecting the one direction.

As a result, the microphone array processing can be performed on the sound acquired by the first microphones 41. When the microphone array processing is performed, the directional noise such as voices of persons other than voices of persons inside the vehicle compartment or wind noise from the air conditioner, for example, can be reduced. When the directional noise is reduced, the SNR of the sound acquired by the first microphones 41 is improved, and the voice recognition rate of the voice recognition engine 75 is also enhanced.

### Third Embodiment

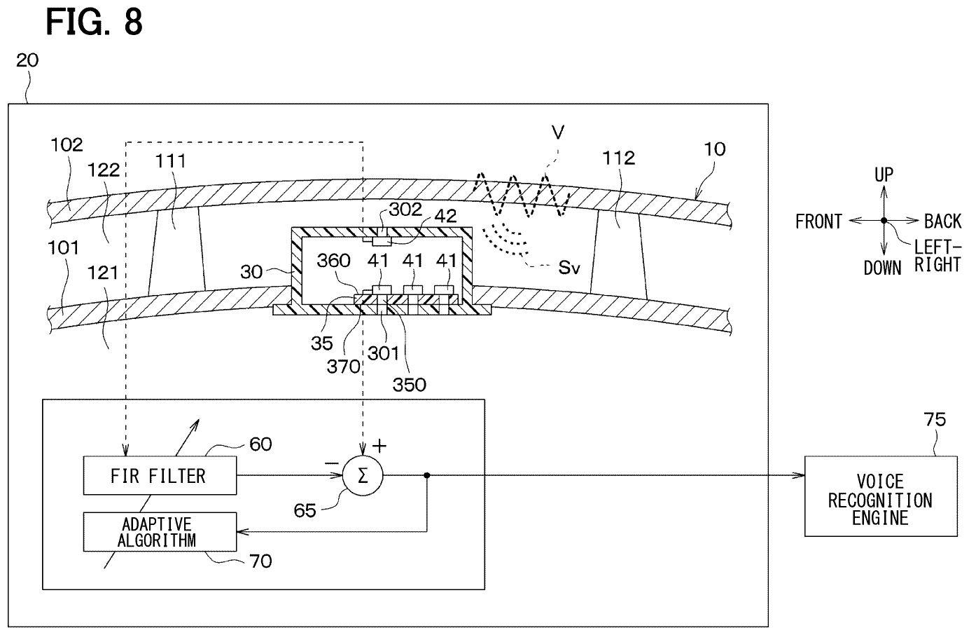

In a third embodiment, as shown in FIG. 8, a sound acquisition device 20 does not include a sound-absorbing member 50 or a sound-insulating member 55. In addition, configurations of a housing 30 and a second microphone 42 differ from those in the second embodiment. Other than these, the configuration is the same as in the second embodiment.

More specifically, the housing 30 has a first housing sound hole 301 and a second housing sound hole 302 instead of the housing sound hole 300. The first housing sound hole 301 corresponds to the housing sound hole 300, and communicates with the first space 121 and the substrate sound hole 350. Therefore, the first microphone 41 acquires sound generated in the first space 121 via the first housing sound hole 301 and the substrate sound hole 350. The second housing sound hole 302 communicates with the second space 122.

The second microphone 42 is housed within the housing 30. Furthermore, the second microphone 42 is disposed within the housing 30 in a vicinity of a position of the second housing sound hole 302. Therefore, the second microphone 42 acquires the vibration sound Sv via the second housing sound hole 302. The second microphone 42 is also connected to the substrate 35 via a wire (not shown).

As described above, the sound acquisition device 20 of the third embodiment is configured in this manner. In this third embodiment as well, the same effects as those of the second embodiment are achieved. Furthermore, the third embodiment also provides the effects described below.

The substrate 35, the first microphone 41, and the second microphone 42 are housed within the housing 30.

As a result, when the housing 30 is attached to the vehicle 10, the substrate 35, the first microphone 41, and the second microphone 42 are also attached to the vehicle 10. Therefore, compared to attaching the first microphone 41 and the second microphone 42 individually to the vehicle 10, it becomes easier to assemble the substrate 35, the first microphone 41, and the second microphone 42 to the vehicle 10.

### Fourth Embodiment

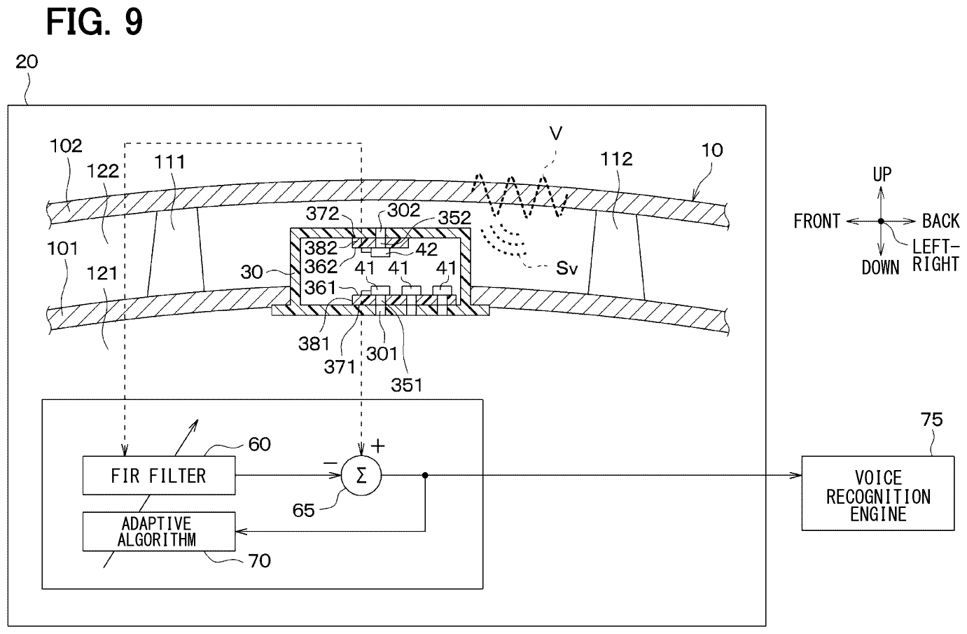

In the fourth embodiment, as shown in FIG. 9, a sound acquisition device 20 is provided with a first substrate 381 and a second substrate 382 instead of the substrate 35. Other than this, the configuration is the same as in the third embodiment.

The first substrate 381 is a printed circuit board. In addition, the first substrate 381 is housed within the housing 30. Furthermore, since the housing 30 is positioned between the first connection member 111 and the second connection member 112 in the front-rear direction, the first substrate 381 is also positioned between the first connection member 111 and the second connection member 112. The first substrate 381 also has a first substrate sound hole 351, a first substrate front surface 361, and a first substrate rear surface 371.

The first substrate sound hole 351 communicates with the first space 121 via the first housing sound hole 301. Here, the first substrate front surface 361 refers to an upper-side surface of the first substrate 381. The first substrate rear surface 371 is a surface of the first substrate 381 opposite to the first substrate front surface 361, and here, it refers to a lower-side surface of the first substrate 381.

The first microphone 41 is disposed near a location of the first substrate sound hole 351 on the first substrate front surface 361. Accordingly, the first microphone 41 acquires sound generated in the first space 121 via the first housing sound hole 301 and the first substrate sound hole 351.

The second substrate 382 is a printed circuit board. Furthermore, the second substrate 382 is housed within the housing 30. In addition, since the housing 30 is positioned between the first connection member 111 and the second connection member 112 in the front-rear direction of the vehicle, the second substrate 382 is also positioned between the first connection member 111 and the second connection member 112. Furthermore, the second substrate 382 has a second substrate sound hole 352, a second substrate front surface 362, and a second substrate rear surface 372.

The second substrate sound hole 352 communicates with the second space 122 via the second housing sound hole 302. Here, the second substrate front surface 362 refers to a surface of the second substrate 382 on the ground side, which faces the first substrate front surface 361 in the vertical direction. The second substrate rear surface 372 is a surface of the second substrate 382 opposite to the second substrate front surface 362, and here refers to an upper surface of the second substrate 382.

The second microphone 42 is disposed near a position of the second substrate sound hole 352 on the second substrate front surface 362. Therefore, the second microphone 42 acquires the vibration sound Sv via the second housing sound hole 302 and the second substrate sound hole 352.

As described above, the sound acquisition device 20 of the fourth embodiment is configured as described. In this fourth embodiment as well, the same effects as those of the third embodiment are achieved.

### Fifth Embodiment

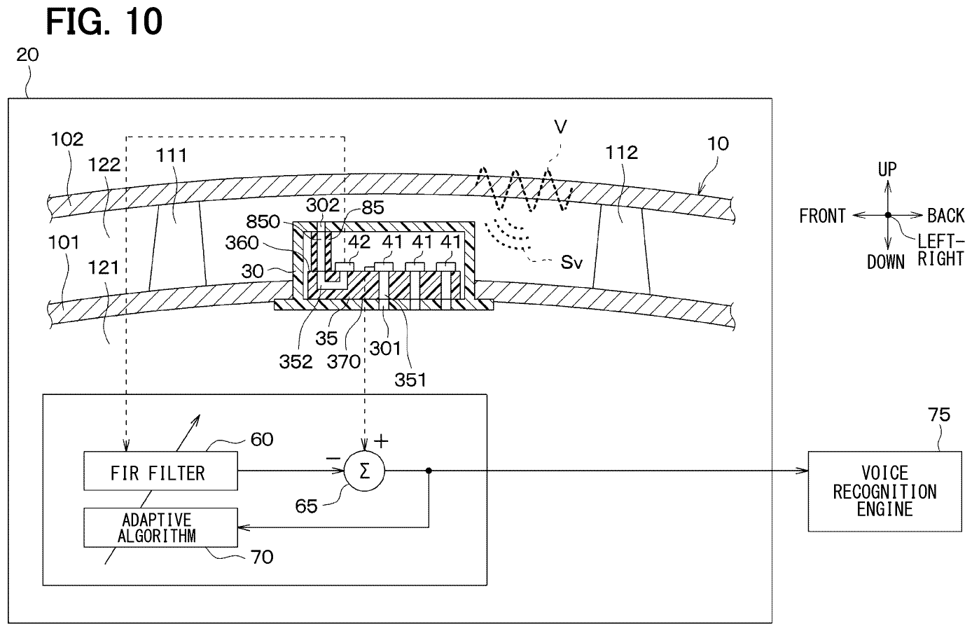

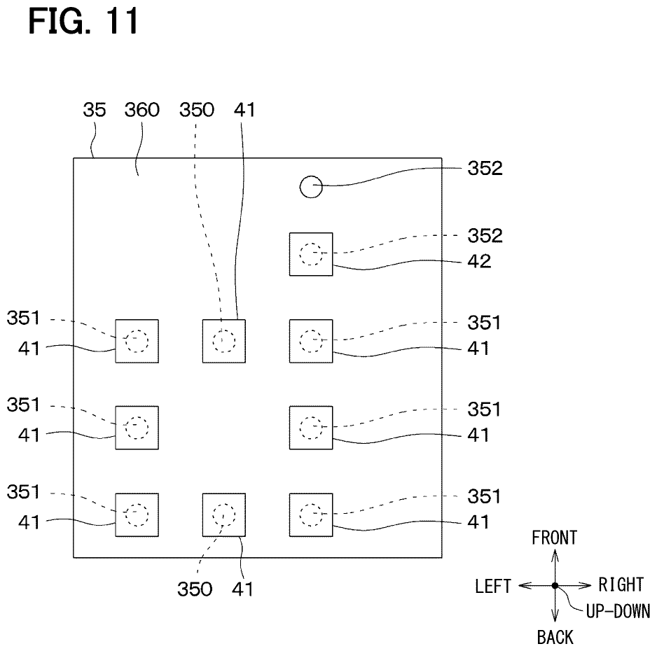

In a fifth embodiment, as shown in FIG. 10, the sound acquisition device 20 is not provided with a sound-absorbing member 50 or a sound-insulating member 55. Further, as shown in FIGS. 10 and 11, the configurations of the second microphone 42 and the substrate 35 differ from those in the second embodiment. Furthermore, as shown in FIG. 10, the sound acquisition device 20 is provided with an isolator 85. In addition, the configuration of the housing 30 differs from that of the second embodiment. Other than these differences, the configuration is the same as in the second embodiment.

More specifically, the second microphone 42 is disposed on a surface of the substrate 35 on which the first microphone 41 is mounted on the substrate front surface 360.

The substrate 35, instead of the substrate sound hole 350, is provided with a first substrate sound hole 351 and a second substrate sound hole 352.

The first substrate sound hole 351 communicates with the first space 121 via the housing sound hole 300. Therefore, the first microphone 41 acquires sound generated in the first space 121 via the housing sound hole 300 and the first substrate sound hole 351.

The second substrate sound hole 352 extends from the substrate front surface 360 toward the second microphone 42 while passing through the interior of the substrate 35.

The isolator 85 is formed from an elastic material such as closed-cell foam sponge, rubber, foamed rubber, clay, or an adhesive. Furthermore, the isolator 85 is disposed between the housing 30 and the substrate front surface 360. As a result, the isolator 85 prevents vibrations of the housing 30 from propagating through the substrate 35 and being detected by the second microphone 42. The isolator 85 also has an isolator sound hole 850. The isolator sound hole 850 communicates with the second substrate sound hole 352.

The housing 30, instead of the housing sound hole 300, has a first housing sound hole 301 and a second housing sound hole 302.

The first housing sound hole 301 communicates with the first space 121 and the first substrate sound hole 351. Accordingly, the first microphone 41 acquires sound generated in the first space 121 via the first housing sound hole 301 and the first substrate sound hole 351.

The second housing sound hole 302 communicates with the second space 122 and the isolator sound hole 850. Therefore, the second microphone 42 acquires the vibration sound Sv via the second housing sound hole 302, the isolator sound hole 850, and the second substrate sound hole 352.

As described above, the sound acquisition device 20 of the fifth embodiment is configured as described. In the fifth embodiment as well, the same effects as those of the second embodiment are achieved. Furthermore, in the fifth embodiment, the effects described below are also achieved.

The second microphone 42 is disposed on the surface of the substrate 35 on which the first microphone 41 is mounted.

As a result, compared to a case where the first microphone 41 and the second microphone 42 are arranged on separate substrates 35, signal transmission paths for the first microphone 41 and the second microphone 42 are shortened. Therefore, when the signals from the first microphone 41 and the second microphone 42 are analog signals, degradation in quality of these signals is reduced. In addition, when the signals from the first microphone 41 and the second microphone 42 are digital signals, a decrease in EMC performance is reduced. EMC stands for Electro Magnetic Compatibility, which refers to electromagnetic compatibility. The analog signal is a signal that express a continuously changing physical quantity. In the present embodiment, the analog signal is an electric signal such as an electric current or a voltage corresponding to the sound. The digital signal is a signal that is discretized with respect to variables such as time and measurements such as electric current and voltage. The discretization refers to converting an analog signal into discrete values.

As a result, it is easier to assemble the substrate 35, the first microphone 41, and the second microphone 42 to the vehicle 10, compared to a case where the first microphone 41 and the second microphone 42 are arranged on separate substrates 35.

As a result, it is easier to mount the first microphone 41 and the second microphone 42 on the substrate 35, compared to a case where the first microphone 41 and the second microphone 42 are arranged on separate substrates 35 or on both sides of the substrate 35. As a result, mounting cost of the first microphone 41 and the second microphone 42 on the substrate 35 is reduced.

### Sixth Embodiment

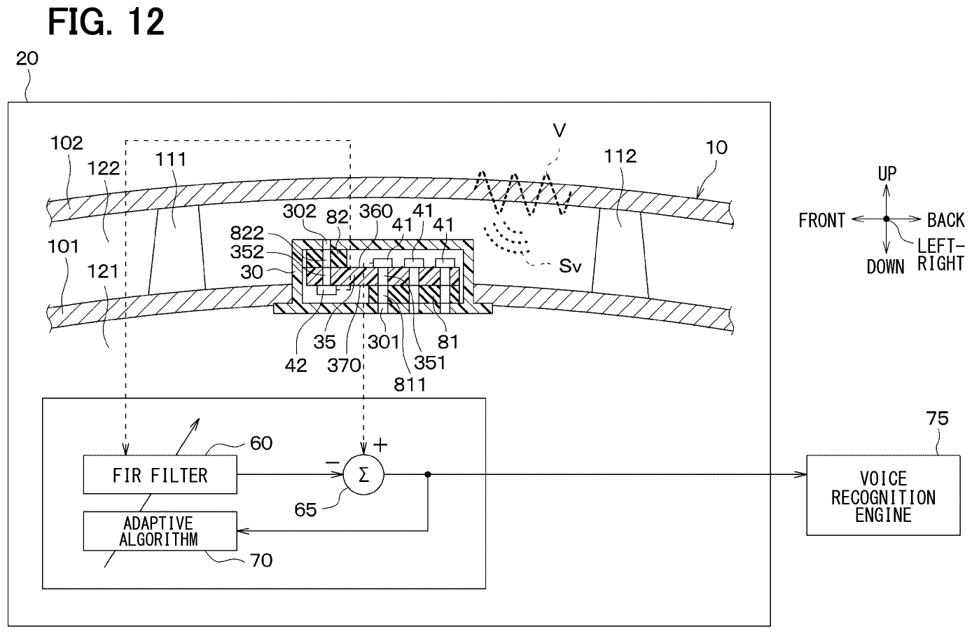

In a sixth embodiment, as shown in FIG. 12, a configuration of a second microphone 42 differs from that of the fifth embodiment. Furthermore, a sound acquisition device 20 is provided with a first isolator 81 and a second isolator 82 instead of the isolator 85. In addition, a configuration of a housing 30 differs from that of the fifth embodiment. Other than these, the configuration is the same as in the fifth embodiment.

The second microphone 42 is disposed on a back surface 370 of the substrate 35 instead of a front surface 360. Accordingly, the second microphone 42 is disposed on a surface of the substrate 35 opposite to the surface on which the first microphone 41 is disposed. Therefore, a second substrate sound hole 352 penetrates through both the front surface 360 and the back surface 370 of the substrate 35.

The first isolator 81 and the second isolator 82 are made of elastic materials such as closed-cell foam sponge, rubber, foamed rubber, clay, or the like, or adhesives.

Further, the first isolator 81 is disposed between the housing 30 and the back surface 370 of the substrate 35. As a result, the first isolator 81 prevents vibrations of the housing 30 from propagating through the substrate 35 and being detected by the first microphone 41. Furthermore, the first isolator 81 has a first isolator sound hole 811. The first isolator sound hole 811 communicates with the first substrate sound hole 351.

Furthermore, the second isolator 82 is disposed between the housing 30 and the front surface 360 of the substrate 35. As a result, the second isolator 82 prevents vibrations of the housing 30 from propagating through the substrate 35 and being detected by the second microphone 42. The second isolator 82 also has a second isolator sound hole 822. The second isolator sound hole 822 communicates with the second substrate sound hole 352.

The first housing sound hole 301 of the housing 30 communicates with the first space 121 and the first isolator sound hole 811. Therefore, the first microphone 41 acquires sound generated in the first space 121 via the first housing sound hole 301, the first isolator sound hole 811, and the first substrate sound hole 351.

The second housing sound hole 302 communicates with the second space 122 and the second isolator sound hole 822. Therefore, the second microphone 42 acquires the vibration sound Sv via the second housing sound hole 302, the second isolator sound hole 822, and the second substrate sound hole 352.

As described above, the sound acquisition device 20 of the sixth embodiment is configured as described. In this sixth embodiment as well, the same effects as those of the fifth embodiment are achieved.

### Seventh Embodiment

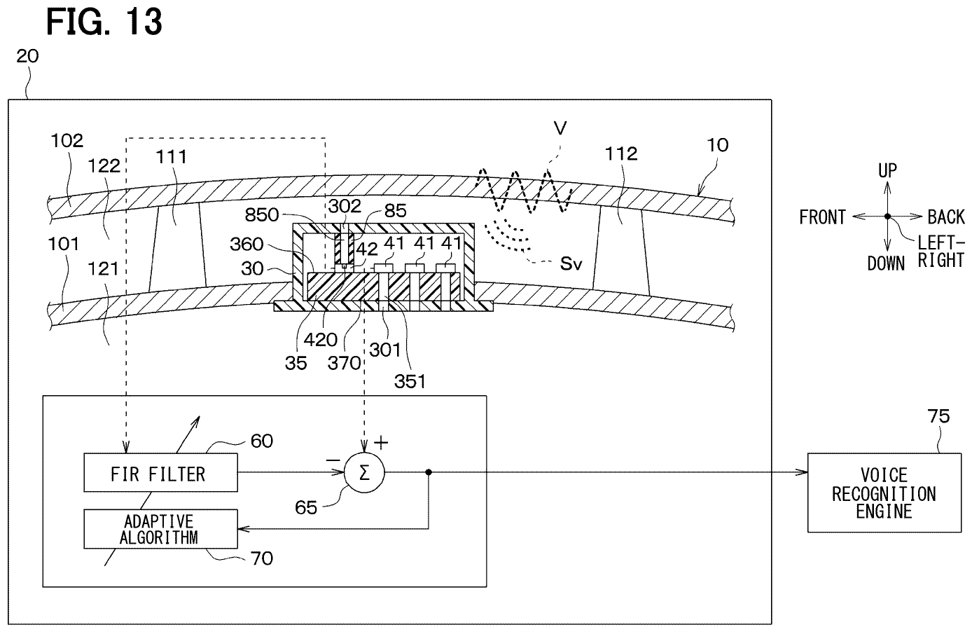

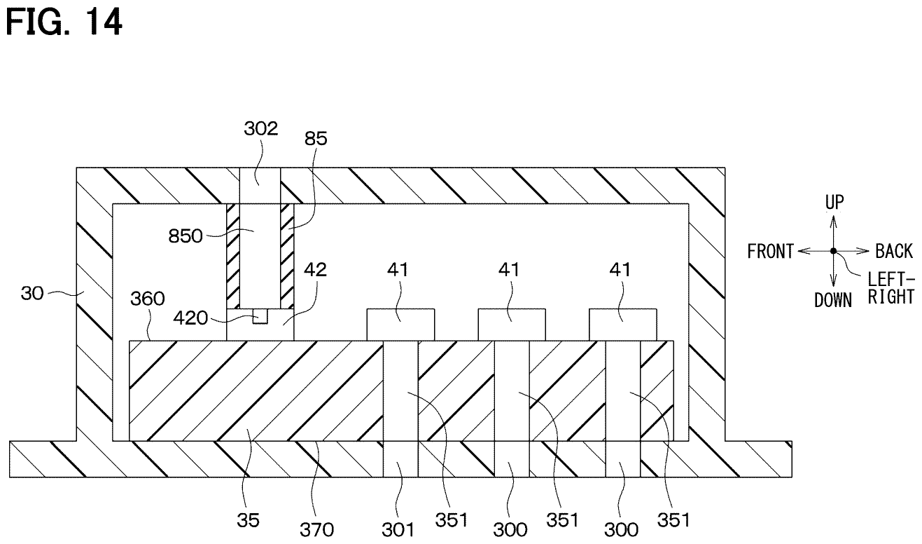

In a seventh embodiment, as shown in FIGS. 13 and 14, a configurations of a substrate 35, a second microphone 42, and an isolator 85 differ from those in the fifth embodiment. Other than this, the configuration is the same as that of the fifth embodiment.

More specifically, the substrate 35 does not have the second substrate sound hole 352. Furthermore, the second microphone 42 has a microphone hole 420. The microphone hole 420 is an opening formed on a side of the second microphone 42 opposite to the front surface 360 of the substrate 35.

The isolator 85 is disposed between the housing 30 and the second microphone 42. As a result, the isolator 85 prevents vibrations of the housing 30 from being detected by the second microphone 42. In addition, the isolator sound hole 850 communicates with the second housing sound hole 302 and the microphone hole 420. Therefore, the second microphone 42 acquires the vibration sound Sv via the second housing sound hole 302, the isolator sound hole 850, and the microphone hole 420.

As described above, the sound acquisition device 20 of the seventh embodiment is configured as described. In this seventh embodiment as well, the same effects as those of the fifth embodiment are achieved.

### OTHER EMBODIMENTS

The present disclosure is not limited to the above-described embodiments, and the above embodiment can be appropriately modified. In the above embodiments, the elements constituting each embodiment are not necessarily essential unless explicitly stated as essential or clearly considered essential in principle.

In each of the embodiments described above, the object 10 is a mobile body. In contrast, the object 10 is not limited to being the mobile body. The object 10 may be a stationary object, such as a room in a building.

In each of the embodiments described above, the mobile body is the vehicle. Contrary to this, the mobile body is not limited to being the vehicle. The mobile body may also be a robot, an airplane, or the like.

In each of the embodiments described above, the mobile body is the vehicle, the first connection member 111 is the B-pillar, and the second connection member 112 is the C-pillar. Contrary to this, the first connection member 111 being a B-pillar and the second connection member 112 being a C-pillar is not a limitation. For example, the first connection member 111 may be an A-pillar, and the second connection member 112 may be a B-pillar. Furthermore, for example, the first connection member 111 may be a C-pillar, and the second connection member 112 may be a D-pillar.

In the fifth embodiment described above, the sound acquisition device 20 includes the isolator 85. Contrary to this, the sound acquisition device 20 does not necessarily have to include the isolator 85. In this case as well, the same effects as those of the fifth embodiment can be achieved.

In the sixth embodiment described above, the sound acquisition device 20 includes the first isolator 81 and the second isolator 82. Contrary to this, the sound acquisition device 20 does not necessarily have to include the first isolator 81 and the second isolator 82. In this case as well, the same effects as those of the fifth embodiment can be achieved.

In the seventh embodiment described above, the sound acquisition device 20 includes the isolator 85. Contrary to this, the sound acquisition device 20 does not necessarily have to include the isolator 85. In this case as well, the same effects as those of the fifth embodiment can be achieved.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A sound acquisition device for use with an object having a first member defining a first space and a second member defining a second space together with the first member, the sound acquisition device comprising:
a substrate having a substrate sound hole communicating with the first space;
a first microphone disposed on the substrate and configured to acquire sound generated in the first space via the substrate sound hole; and
a second microphone disposed in the second space and configured to acquire vibration sound generated by the second member, wherein
a coherence of the vibration sound acquired by the second microphone with respect to the sound acquired by the first microphone is 0.4 or greater.

2. The sound acquisition device according to claim 1, wherein the object is a mobile body,
the first member is an interior member installed in the mobile body,
the second member is a ceiling member forming a ceiling of the mobile body,
the mobile body includes:
a first connection member connected to the second member and extending in a direction intersecting both a front-rear direction and a left-right direction of the mobile body; and
a second connection member connected to the second member at a position rearward of the first connection member in the front-rear direction and extending in a direction intersecting both the front-rear direction and the left-right direction, and
the first microphone and the second microphone are positioned between the first connection member and the second connection member in the front-rear direction.

3. The sound acquisition device according to claim 2, wherein
a center of the mobile body in the left-right direction is a reference position,
a distance from the reference position to the first microphone in the left-right direction is 300 mm or less, and
a distance from the reference position to the second microphone in the left-right direction is 300 mm or less.

4. The sound acquisition device according to claim 2, wherein
the mobile body is a vehicle, and
the first member and the second member are plate-shaped members extending in a direction orthogonal to a vertical direction.

5. The sound acquisition device according to claim 1, wherein
the first microphone is one of first microphones, and
the first microphones are arranged in rows in one direction and in rows in a direction intersecting the one direction.

6. The sound acquisition device according to claim 1, further comprising:
a housing accommodating the substrate, the first microphone, and the second microphone, wherein
the housing has:
a first housing sound hole communicating with the first space and the substrate sound hole; and
a second housing sound hole communicating with the second space,
the first microphone is configured to acquire the sound generated in the first space via the first housing sound hole and the substrate sound hole, and
the second microphone is configured to acquire the vibration sound via the second housing sound hole.

7. The sound acquisition device according to claim 6, wherein
the substrate is a first substrate,
the substrate sound hole is a first substrate sound hole,
the sound acquisition device further comprising:
a second substrate accommodated in the housing,
the second substrate has a second substrate sound hole communicating with the second housing sound hole, and
the second microphone is disposed on the second substrate and configured to acquire the vibration sound via the second housing sound hole and the second substrate sound hole.

8. The sound acquisition device according to claim 1, wherein
the first member is an interior member installed in the object,
the second member is a ceiling member forming a ceiling of the object, and
when the first microphone is projected in a vertical direction, the projected first microphone overlaps with the second microphone.

9. The sound acquisition device according to claim 1, wherein
the second microphone is disposed on a first surface of the substrate on which the first microphone is disposed,
the substrate sound hole is a first substrate sound hole,
the substrate has a second substrate sound hole extending from the first surface through an inside of the substrate toward the second microphone,
the sound acquisition device further comprising:
a housing accommodating the substrate, the first microphone, and the second microphone,
the housing has:
a first housing sound hole communicating with the first space and the first substrate sound hole; and
a second housing sound hole communicating with the second space and the second substrate sound hole,
the first microphone is configured to acquire the sound generated in the first space via the first housing sound hole and the first substrate sound hole, and
the second microphone is configured to acquire the vibration sound via the second housing sound hole and the second substrate sound hole.

10. The sound acquisition device according to claim 1, wherein
the second microphone is disposed on a second surface of the substrate opposite to a first surface on which the first microphone is disposed,
the substrate sound hole is a first substrate sound hole,
the substrate has a second substrate sound hole penetrating both the first surface and the second surface;
the sound acquisition device further comprising:
a housing accommodating the substrate, the first microphone, and the second microphone,
the housing has:
a first housing sound hole communicating with the first space and the first substrate sound hole; and
a second housing sound hole communicating with the second space and the second substrate sound hole,
the first microphone is configured to acquire the sound generated in the first space via the first housing sound hole and the first substrate sound hole, and
the second microphone is configured to acquire the vibration sound via the second housing sound hole and the second substrate sound hole.

11. The sound acquisition device according to claim 1, wherein
the second microphone is disposed on a first surface of the substrate on which the first microphone is disposed,
the second microphone has a microphone hole at a portion thereof on a side opposite to the first surface,
the sound acquisition device further comprising:
a housing accommodating the substrate, the first microphone, and the second microphone,
the housing has:
a first housing sound hole communicating with the first space and the substrate sound hole; and
a second housing sound hole communicating with the second space and the microphone hole, and
the second microphone is configured to acquire the vibration sound via the second housing sound hole and the microphone hole.
